(19) United States
(12) Patent Application Publication
(10) Pub. No.: US 2005/0052339 A1
(43) Pub. Date: Mar. 10, 2005

(54) Electroluminescent programmable signs for use onboard an aircraft

(76) Inventor: Linda J. Sprague, Seattle, WA (US)

Correspondence Address: HARNESS, DICKEY & PIERCE, P.L.C., P.O. BOX 828, BLOOMFIELD HILLS, MI, 48303, US

(21) Appl. No.: 10/658,658

(22) Filed: Sep. 9, 2003

(51) Int. Cl. G09G 5/00

(52) U.S. Cl. 345/1.1

(57) ABSTRACT

An apparatus and method to reduce the life cycle cost associated with aircraft signs. The apparatus includes a display attached to the aircraft. The apparatus also includes a memory coupled to the display which stores a plurality of pieces of information and a circuit coupled to the memory. The circuit causes at least one of the pieces of information to appear on the display, whereby the circuit may change the information displayed on the display. Moreover, the information may include a plurality of aircraft sign images and the apparatus may include a data port for changing the displayed information and for modifying the stored information. Additionally, the data port may be for either wireless or a hard wired connection. Also, the display may be an organic electroluminescent device.

### FIELD OF THE INVENTION

The present invention relates to aircraft signs, and more particularly to programmable signs for use on board an aircraft.

### BACKGROUND OF THE INVENTION

On commercial aircraft a number of signs convey information to the passengers and crew. Some of the information is placed on these signs to aid the passengers in egressing from aircraft, to remind the passengers not to smoke at appropriate times, to inform them to fasten their seat belts or return to their seats, to inform them of the location of lavatories and whether a particular lavatory is occupied.

Each type of sign requires a specific/unique lens that differs from lenses used with other signs. That is, for example, door exit signs require one type of lens, aisle exit signs require another, and lavatory signs another. The lens covers a back lighting illumination source for the sign. Additionally, because air travel involves people who use many different languages, separate sets of lenses are required for each of the dozens of frequently used languages. Moreover, each airline may have a preference for the language (and the appearance of the language, e.g. font) and symbols used on the sign which necessitates the creation of a unique set of lenses for each airline. Likewise, each aircraft configuration may impose different envelope requirements on the set of signs for use on that aircraft.

Accordingly, providing a full compliment of the various required sign permutations presents aircraft manufacturers, retrofitters, airlines, leasers, and other aircraft operators a logistical problem. Spares must be kept on hand to replace broken and worn signs. When a change is desired or mandated, the existing lenses must be removed, replaced, and scrapped. Should an error be discovered, particularly translation errors, the affected signs must also be likewise removed, replaced, and scrapped. Thus supporting an inventory of signs consumes resources and contributes to the cost of air travel.

### SUMMARY OF THE INVENTION

The present invention provides an apparatus and method to reduce the life cycle cost associated with specific signs used in a mobile platform. The invention is especially well suited to use with signs used in commercial passenger carrying aircraft. A preferred embodiment of the apparatus includes a display attached to the aircraft. The apparatus also includes a memory coupled to the display which stores a plurality of pieces of information and a circuit coupled to the memory. The circuit causes at least one of the pieces of information to appear on the display, whereby the circuit may change the information displayed on the display. Moreover, the information may include a plurality of aircraft sign images and the apparatus may include a data port for changing the displayed information and for modifying the stored information. Additionally, the data port may be for either a wireless or a hard wired connection. Also, the display may be an organic electroluminescent device.

In another preferred embodiment the present invention provides a method of using a programmable display to convey information to passengers onboard a mobile platform, for example, an aircraft. The method includes coupling the display to an aircraft and programming the display to display at least one of the plurality of pieces of information, whereby the display replaces a sign on the aircraft. The plurality of pieces of information may include a plurality of sign images such as an exit sign image, a lavatory sign image, a lavatory occupied sign image, a lavatory not occupied sign image, a no smoking sign image, a return to seat sign image, and a fasten seat belt sign image.

The method may also include electromagnetically coupling a controller to the display and changing which of the plurality of pieces of information the display displays. In the alternative, the plurality of pieces of information may be modified. Moreover, the electromagnetic coupling may be either a wireless or a hardwired coupling.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an aircraft interior incorporating a preferred embodiment of the present invention.

FIG. 2 is a plan view of a passenger information display in accordance with a preferred embodiment of the present invention.

FIG. 3 is a perspective view of an electroluminescent display in accordance with a preferred embodiment of the present invention.

FIG. 4 is a block diagram view of an electroluminescent display in accordance with a preferred embodiment of the present invention.

FIG. 5 is a schematic view of a network of displays in accordance with a preferred embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

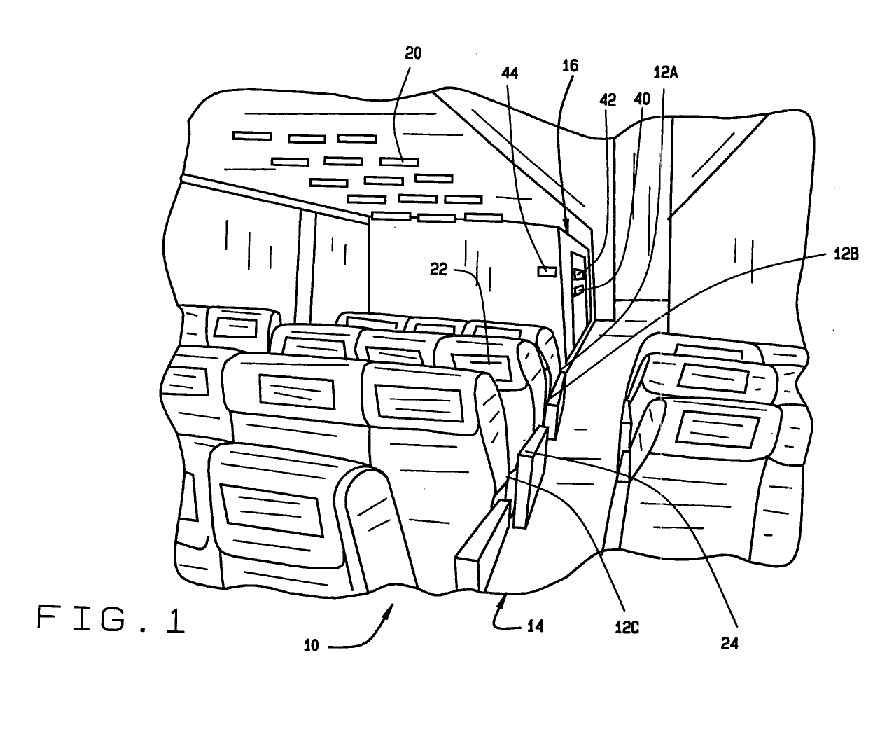

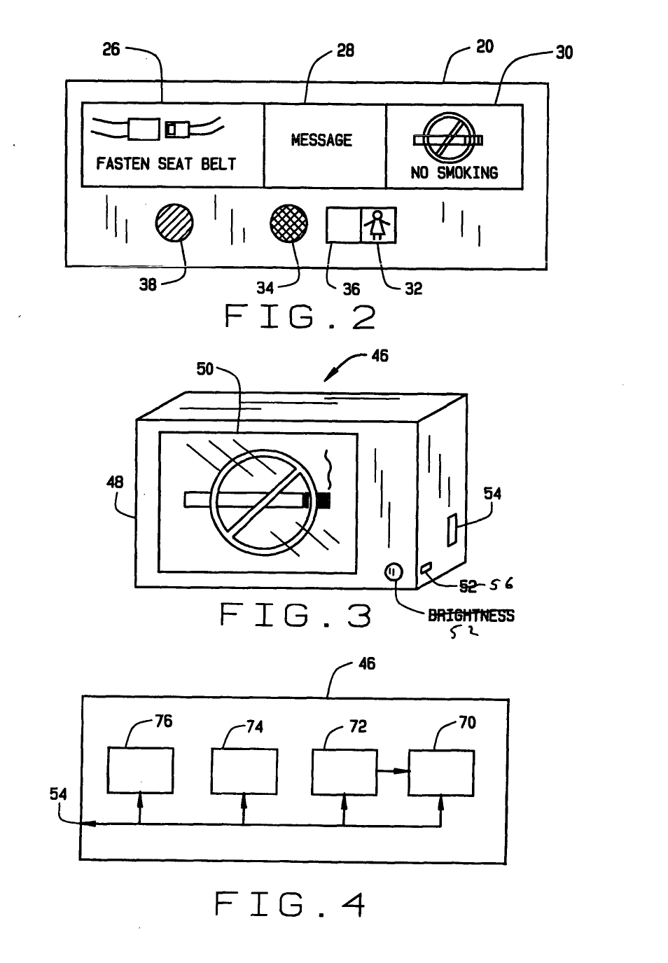

With reference now to FIG. 1, an aircraft 10 is shown. The aircraft 10 includes rows of passenger seats 12 along a central aisle 14. For passenger comfort, the aircraft 10 includes a lavatory 16 and a crew work station 18. Above each passenger seat 12, or row of passenger seats, an overhead console 20 (see FIG. 2) is provided for each passenger, or row of passengers.

Various displays are provided in the interior of the aircraft 10, some of which are mandated by the U.S. Federal Aviation Administration (FAA) and counterpart foreign agencies, and some are provided as a courtesy to the passengers. For instance, on the passenger seat 12A a seat back display 22 is provided for the passenger sitting in seat 12B. An arm rest display 24 may also be provided on each of the seats 12 as shown with seat 12C. Note, that while the various displays illustrated herein have been shown in the interior of the aircraft, the present invention is not so restricted. In particular, the displays provided by the present invention may also be used for a wide variety of exterior aircraft markings and signs.

Over the seat 12B an overhead console 20 may provide additional displays as shown in FIG. 2. For instance, a “Fasten Seat Belt” 26 display, a message display 28, and a “No Smoking” display 30 are shown. In addition various passenger controls and features may be provided such as a crew call button 32, an individual reading light 34, light switch 36, and an air conditioning vent 38. The overhead console 20 may serve one passenger and approximate the width of the seat 12, or the console can serve an entire row on one side of the aisle 14. In the latter case, the overhead console includes a crew call button 32, an individual reading light 34, light switch 36, and an air conditioning vent 38 for each seat in the row. The “Fasten Seat Belt” message and “No Smoking” displays 26 to 30 may also be duplicated for each passenger or may be sized for convenient viewing by all passengers in that row. The lavatory 16 may also include one or more lavatory displays 40 to aid the passenger in finding the lavatory 16. On the door of the lavatory 16 a display 42 may indicate whether the lavatory is occupied or vacant based on an input to the display from the door lock or a motion or heat detector viewing the lavatory compartment. Since the crew work station is sometimes aft of the lavatory section, FIG. 1 also shows a crew display 44 on the structure surrounding the lavatory 16.

It will be understood that the various displays 22 to 30 and 40 to 44 are deemed displays rather than signs because of the improved capabilities provided by the displays over conventional signs. A conventional sign typically includes a lens which bears the text and graphics which give the sign its overall appearance and which conveys the desired information to the viewer. Typically, a light source back lights the lens to provide the desired (or required) brightness and contrast. To change, update, or correct the sign the lens must be removed and replaced because a conventional sign has no real time modification capabilities.

In contrast, the displays in accordance with the principles of the present invention may be modified in real time. Additionally, because the displays may be programmed, one configuration (e.g. size) of display may be used to display all of the information previously conveyed by signs of the prior art. Such a multi function display 46 is shown in FIG. 3. For illustration purposes a “No Smoking” symbol is shown displayed within the display 46 thereby showing how the display 46 may function as a “No Smoking” sign.

The display 46 includes a frame or body 48, a viewing screen 50, a control 52 (e.g. an on/off switch or brightness knob) a power cord, connector, jack, or other conventional power connection 54, and a data port 56. The frame 48 is adapted to connect to suitable aircraft structure in the various locations where signs are desired. The viewing screen 50 may be any type of screen such as an LED panel, an LCD, a plasma, or an organic or an inorganic electroluminescent (EL) device.

In a preferred embodiment the screen 50 is an organic electroluminescent device. Organic electroluminescent devices enjoy many advantages over other types of screens. In particular, the lower power consumption of organic EL devices lowers the power consumption of a system of displays over the other available technologies. The organic EL Device also weighs less than the other devices and requires no inverter (as some other devices do) thereby allowing a light weight solution for aircraft use. Being solid state, the organic EL display also enjoys high reliability.

Additionally, the organic EL device is thinner (measured in millimeters). Thus organic EL displays can be placed in shallow inserts in walls and other aircraft interior structures with adhesive securing the display to the structure. Moreover EL displays distribute the displayed image more uniformly over a given view angle than other devices. Viewing of the sign may even occur at angles of up to 80 degrees. It will also be understood by those skilled in the art, that organic EL devices meet the brightness and contrast FAA requirements for aircraft signs for all colors, particularly white. Thus, the display 46 may be certified for use on board commercial aircraft.

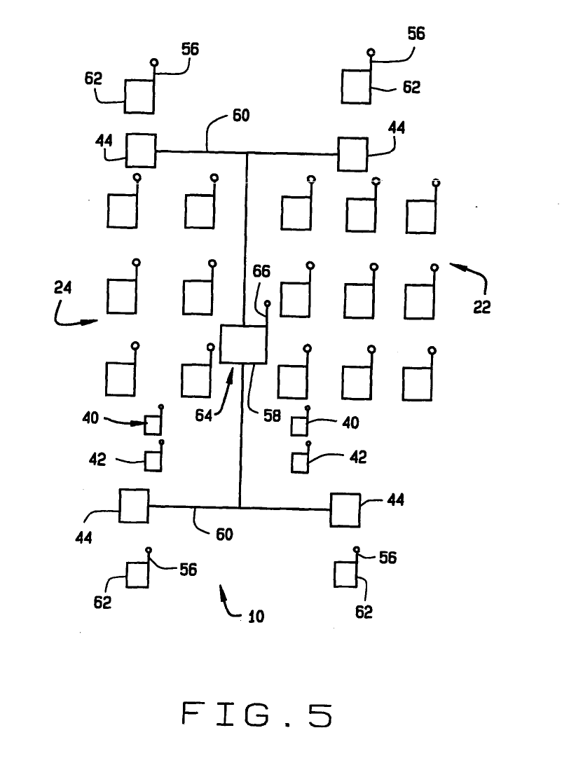

Referring still to FIG. 3, the power jack 54 and data port 56 are shown in FIG. 3 located on the side of the display 46. However, they may be provided on the back in the form of a pin, or hole, type connector so that the power and data connections may be made with mating aircraft connectors when the display 46 is inserted into its operational location on the aircraft. The data port 56 allows the display 46 to communicate with a programming device, a personal computer, computer network, or other communications device. In one preferred embodiment, the data port includes an antenna or receiver for receiving electromagnetic signals (e.g. radio frequency signals). Regardless of the medium over which data port 56 communicates, data port 56 receives programming and control signals from a controller 58 (see FIG. 5).

Internally, as shown in FIG. 4, the display 46 includes memory 70 to hold the graphics, text, and combinations thereof necessary to create the signs which will be displayed on the screen 50. The display 46 may also include a graphics or video driver 72 to convert the stored images to electronic signals which the screen 74 (or screen drivers) converts to the images. In addition, the display 46 includes a circuit 76 (e.g. a microprocessor, gate array, or state machine) which accepts the commands from the controller 58, causing the images stored in the memory 70 to be displayed on the screen 74, and for generating return messages (e.g. command confirmations or built in test equipment results) via the data port 56. Thus, the display 46, when connected to the controller 58 or otherwise networked, can be manipulated by the user. For instance, a translation, artwork, or typographical error in a sign image may be corrected in real time without having to scrap the inventory of affected signs.

The memory may also be connected to the data port so that an external programming device can access the memory 70 and store new images in, and delete old images from, the memory 70. These modifications may take only minutes to execute as opposed to the weeks necessary to create a new prior art sign. Thus, according to which information the user desires to store in the memory 70, any message or sign in any language may be stored in, and displayed by, the display 46. Accordingly, the inventory of signs necessitated by the prior art may be eliminated and replaced with a much smaller inventory of displays 46. For lease carriers, who may frequently retrofit an aircraft for a new airline, the present invention provides a degree of flexibility in reconfiguring the aircraft signs heretofore unavailable.

In the alternative, the data port 56 may accept video and graphics images for display on the screen. Thus, for example, the display may be compatible with the Connexion by Boeing^{SM} system, thereby enabling display of internet material, movies, or advertisements on the display 46. Additionally, the display 46 may be made interactive with, for example, touch screen technology.

In FIG. 5, controller 58 is shown connected to four crew displays 44 via a high bandwidth data bus 60. Also shown in FIG. 5, the controller communicates with four exit displays 62 equipped with antenna type data ports 56, and a plethora of seat back and arm rest displays 22 and 24, lavatory displays 40 and 42, and exit displays 62 via a wireless (radio frequency or other electromagnetic wave based) communication system. Accordingly, the controller 54 includes a network data port 64 and an antenna type data port 66 four. While, the crew displays 44 were shown connected via the high bandwidth data bus 60 and the other displays were shown with low bandwidth radio frequency links, any combination of connection schemes is within the spirit and scope of the present invention. Thus the controller 58 may control the various displays and receive data from them in turn.

For instance, during a typical flight the crew may use the system as follows. As the aircraft is readied for passenger ingress, the crew may command the controller 58 to change the image displayed on the message displays 28 to an image conveying a desired message to the passengers. Moreover, the crew could enter the command via an interactive feature (e.g. graphic user display) on one of the crew displays 44. In turn, the controller 58 sends a signal, or issues a command, via the data bus 60 to the message displays 28 to display the desired (or required) graphics or text (e.g. new aircraft sign messages “WELCOME”, “THIS IS A NO SMOKING FLIGHT”, “TURBULENCE AHEAD”, or “DO NO USE ELECTRONIC EQUIPMENT DURING TAKEOFF AND LANDING”.). In turn, the message displays 28 modify the image displayed on their individual screens to at least include the appropriate image.

As passengers ingress the aircraft 10, the crew may also command the message displays 28 (of FIG. 2) to display a welcome greeting, advertisements, destination information, information regarding the onboard entertainment system (e.g. audio and visual channel guides), and carry-on luggage stowing or emergency instructions. During the pre take-off emergency briefing given the passengers, written instructions and diagrams can be displayed on the message displays 28. After the briefing ends, the message displays 28 may then be commanded to display passenger requested images.

As implied in the above description, certain displays may be dedicated to displaying “Exit”, “Fasten Seat Belt”, “No Smoking” sign images. In the alternative, the various displays may switch roles (e.g. a message display 28 may display a “Fasten Seat Belt” symbol should the fasten seat belt display 26 fail. Role switching may be commanded by the crew, or automatically by the controller 58. For instance, the various displays may include built in test equipment to monitor their own performance, should the built in test equipment detect an off nominal condition the display may send a signal to the controller 58 indicating the problem. The controller could then send an adjacent, or nearby, display to switch roles with the display which is indicating an anomaly.

Note though, that aircraft signs are typically divided into two broad categories: emergency signs and lighted signs. Emergency signs are used for evacuation of the aircraft under emergency conditions. They include “Exit” signs and indicators. “Exit” signs signal an exit from a door and lead passengers to the door from the aisles and other areas of the aircraft. Exit indicators are part of what is known as the floor proximity and must be within 18 inches of the floor. These exit indicators are placed there to lead passengers to the exit should people need to crawl from the aircraft during emergency conditions

Accordingly, the F.A.A. closely regulates emergency signs. For instance, emergency signs may not include any message except those allowed by F.A.R. 25.812 (e.g. “Exit”). Thus, in practice, the “Exit” displays are not multi-use. Nonetheless, “Exit” displays may still enjoy the advantages of the present invention because they can still be programmed to display the message in any language along with an appropriate symbol. Likewise, the “Fasten Seatbelt” and “No Smoking” displays, in practice, are likewise regulated. Though, they also enjoy the benefits of the present invention via the ability to display the message in any language and with an appropriate symbol.

However, the lavatory, lavatory occupied, return to seat, and other displays are not restricted to one message and may be multi-use. Accordingly, these displays may contain any message, be it pertinent to the flight, commercial, entertainment, or otherwise (e.g. in practice these displays may be multi-function message boards). Moreover, these signs may be designed per customer choice.

It will be appreciated that the present invention thus provides displays to replace aircraft signs. Moreover, the displays are efficient, flexible, durable, inexpensive, and highly reliable. Also, the display generate no tangible heat. In particular, the organic electroluminescent displays in accordance with the present invention consume as little as a few watts from a low voltage (5-9 VDC) source. These types of high contrast displays may also be viewed clearly from angles of up to 80 degrees. Additionally, because one part number (i.e. one configuration of display) may satisfy all of the sign needs for any aircraft, artwork costs are essentially eliminated.

While the foregoing description has focused on an implementation of the invention in a passenger aircraft, it will be appreciated that the present invention is not limited to use only in aircraft, or in aviation in general. The present invention can be employed in any mobile platform (e.g., bus, train, ship, etc.) where a number of signs are used that need to be changed periodically, or even in a fixed structure where a plurality of signs would need to be periodically changed to display different messages.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A method of using a programmable display to convey a plurality of pieces of information, the method comprising:
locating the display on a mobile platform; and
programming the display to display at least one of plurality of different pieces of information, whereby the display replaces a non-alterable, fixed message sign on the mobile platform.

2. The method according to claim 1, wherein the plurality of pieces of information includes a plurality of differing sign images.

3. The method according to claim 2, wherein the plurality of sign images includes at least one or more of:
an exit sign image, a lavatory sign image, a lavatory occupied sign image, a lavatory not occupied sign image, a no smoking sign image, a return to seat sign image, and a fasten seat belt sign image.

4. The method according to claim 1, wherein the plurality of pieces of information to includes a graphic symbol.

5. The method according to claim 1, further comprising electromagnetically coupling a controller to the display.

6. The method according to claim 5, further comprising signaling the display to change which of the plurality of pieces of information the display displays

7. The method according to claim 5, further comprising modifying the plurality of pieces of information.

8. An apparatus comprising:
a display supported on an area of a mobile platform;
a memory in communication with the display to store a plurality of differing pieces of information; and
a circuit coupled to the memory to select one of the pieces of information to appear on the display, the circuit being operable to change the information displayed on the display in accordance with a newly selected piece of said stored information, and wherein the apparatus replaces a non-alterable sign on the mobile platform.

9. The apparatus according to claim 8, wherein the plurality of pieces of information include a plurality of sign images.

10. The apparatus according to claim 9, wherein the plurality of sign images includes one or more of:
an exit sign image, a lavatory sign image, a lavatory occupied sign image, a lavatory not occupied sign image, a no smoking sign image, a return to seat sign image, and a fasten seat belt sign image.

11. The apparatus according to claim 8, wherein the plurality of pieces of information include a graphic symbol.

12. The apparatus according to claim 8, further comprising a data port electromagnetically coupled to one or more of the circuit and the memory.

13. The apparatus according to claim 12, wherein the data port operates to accept a signal, the signal operating to change which of the plurality of pieces of information the display is to display.

14. The apparatus according to claim 12, wherein the data port operates to accept a signal, the signal operating to modify the plurality of pieces of information.

15. The apparatus according to claim 12, wherein the data port further comprising a wireless data port.

16. The apparatus according to claim 12, wherein the data port further comprises a hard wired device.

17. The apparatus according to claim 8, wherein the display further comprises an organic electroluminescent device.

18. The apparatus according to claim 8, wherein the area of the aircraft further comprises an interior area of the aircraft.

19. The apparatus according to claim 8, wherein the display is dedicated for a particular message in any language.
